(19) United States
(12) Patent Application Publication
(10) Pub. No.: US 2012/0324557 A1
(43) Pub. Date: Dec. 20, 2012

(54) SYSTEM AND METHOD FOR REMOTE INTEGRITY VERIFICATION

(75) Inventors: Jonathan A. Rubin, Bedford, MA (US); John H. Lowry, Pepperell, MA (US)

(73) Assignee: Raytheon BBN Technologies Corp, Cambridge, MA (US)

(21) Appl. No.: 13/163,148

(22) Filed: Jun. 17, 2011

(51) Int. Cl. H04L 9/32

(52) U.S. Cl. 726/7

(57) ABSTRACT

Systems and methods are disclosed herein for verifying the integrity of a remote computing device. The system includes a challenge processor in communication with a communication device. The challenge processor selects a challenge from a plurality of challenges for determining the integrity of a computer program on a remote computing device. The challenge is selected in a manner which is substantially unpredictable by the remote computing device. The communication device transmits the challenge to the remote computing device and receives an output of the challenge. The challenge processor is also configured to determine from the output of the challenge whether the integrity of the computer program on the remote computing device has been compromised.

### FIELD OF THE INVENTION

In general, the invention relates to a computerized system and method for verifying the integrity of a remotely located computing device.

### BACKGROUND OF THE INVENTION

Software developers and distributors often write license agreements that users of the software must abide by. License agreements include provisions related to permission to modify the software, the number of installations or devices upon which software may be installed, and prohibitions against viewing source code and reverse engineering, among other things.

Violations of such agreements can be harmful to both the software distributor and other users. Distributing and using unauthorized copies of software takes potential revenue from software distributors. This, in turn, can lead software distributors to increase their prices for paying customers. For gaming software, violation of agreements can create an uneven playing field among players. Computer gamers and online gamblers can modify their software to gain advantages over their peers. In online gambling, software modifications may affect not only the experience of the other players, but also the payouts from online casinos. In another case, modifications to voting software can affect the outcome of a poll or election.

Various techniques have been developed for determining if a process or program running on a computer has been modified. Such techniques include embedding code into software that performs integrity checks, or requiring installation of an additional program that performs integrity checks. These integrity checks include hash functions, checksum functions, and other forms of verification that the software or specific data has not been modified. Integrity checks that are installed along with software can be reverse-engineered by users of the software and the expected results predicted and spoofed through modification or emulation. Users can also spoof integrity checks initiated from an outside source if they know or can anticipate the types of integrity checks used.

### SUMMARY OF THE INVENTION

There is therefore a need in the art for a more sophisticated system and method for verifying the integrity of software running on a remote computing device. One such system includes a server that can exchange data with the remote computing device. This architecture is more dynamic than a verification system on the device alone. One such method involves selecting a challenge at the server, sending the challenge to the remote client device, and interpreting an output of the challenge at the server. By selecting the challenges in an unpredictable manner, it is very difficult for a user of the remote client device to anticipate every challenge or modify the software in a way that is undetectable to every challenge. The challenges are made unpredictable, for example, by structuring them as arbitrary executable code that is injected into the software running on the remote device. Additionally, since an administrator controls the server and can input additional challenges onto the server, the body of challenges from which the server can select can expand over time, presenting more and more variation in the challenges sent to the remote client device.

The server being remote from the computing device and controlling the verification system allows the definition of a challenge and detectable outputs to expand over previous verification methods. The server can observe or direct other computing devices to observe side effects from certain challenges. Even if a user has configured his computing device to return the correct challenge results to the server, for example by using an emulation, the user may not be able to control all side effects or anticipate which side effects will be observed. Thus, a server-based verification system working in conjunction with additional computing devices is a significant improvement over previous verification systems.

Accordingly, systems and methods are disclosed herein for verifying the integrity of a remote computing device. The system includes a challenge processor in communication with a communication device. The challenge processor selects a challenge from a plurality of challenges for determining the integrity of a computer program on a remote computing device. The challenge is selected, from the perspective of the remote computing device, in a manner which is substantially unpredictable. The communication device transmits the challenge to the remote computing device and receives an output of the challenge. The challenge processor is also configured to determine from the output of the challenge whether the integrity of the computer program on the remote computing device has been compromised.

In some embodiments, the challenge processor selects the challenge from the plurality of challenges using a random number generator or a pseudorandom number generator. The challenge may be a hash function, and one or more parameters of the hash function may be selected in a substantially unpredictable manner.

In some embodiments, the challenge requires the computer program on the remote computing device to exhibit a behavior that can be observed by a second computer program on the remote computing device. The second computer program on the remote computing device may be configured to report an observation of the behavior to the challenge processor. In other embodiments, the challenge causes the remote computing device to exhibit a behavior that is detectable by a second computing device. The challenge processor then determines, from data from the second computing device related to evidence of the behavior of the remote computing device, whether the integrity of the computer program on the remote computing device has been compromised. In such an embodiment, the challenge processor can cause the communication device to transmit to the second computing device a command to detect the behavior of the remote computing device. The second computing device may be in communication with the remote computing device through a network.

In some embodiments, the challenge processor selects a delay after which the challenge is to be executed by the remote computing device. The delay can be selected in a substantially unpredictable manner. In other embodiments, the challenge processor selects a deadline by which the output of the challenge must be received. The expected output of the challenge may relate to aspects of the remote computing device other than the computer program. The output may indicate whether actions of a user of the remote computing device are permissible according to a license agreement.

If the challenge processor determines from an output of a first challenge that the integrity of the computer program on the remote computing device may be compromised, the challenge processor may select an additional challenge that is different from the first challenge, cause the communication device to transmit the additional challenge to the remote computing device, and evaluate the output of the additional challenge. If the actions of a user of the remote computing device are not permissible according to the license agreement, a policy enforcement processor selects for execution an action articulated by the license agreement. For example, the policy enforcement processor can select for execution at least one of: a temporary suspension on the remote computing device, a warning for delivery to the remote computing device, a command to disable the connection between the remote computing device and the system, a command to terminate a user account, a command to copy the memory of the remote computing device, and an alert to a system administrator.

According to another aspect, the invention relates to computerized methods for carrying out the functionalities described above. According to another aspect, the invention relates to non-transitory computer readable medium having stored therein instructions for causing a processor to carry out the functionalities described above.

### BRIEF DESCRIPTION OF THE DRAWINGS

FIG. 1 is an architectural model of a system for verifying the integrity of a remote computing device, according to an illustrative embodiment of the invention.

FIG. 2 is flowchart of a method for verifying the integrity of a remote computing device, according to an illustrative embodiment of the invention.

FIG. 3 is an architectural model of a system for verifying the integrity of a remote computing device running a plurality of computer programs, according to an illustrative embodiment of the invention.

FIG. 4 is an architectural model of a system for verifying, using a second computing device, the integrity of a remote computing device, according to an illustrative embodiment of the invention.

FIG. 5 is a flowchart of a method for verifying the integrity of a remote computing device and taking an action based on the integrity of the remote computing device, according to an illustrative embodiment of the invention.

### DESCRIPTION OF CERTAIN ILLUSTRATIVE EMBODIMENTS

To provide an overall understanding of the invention, certain illustrative embodiments will now be described, including systems and methods for remote integrity verification. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

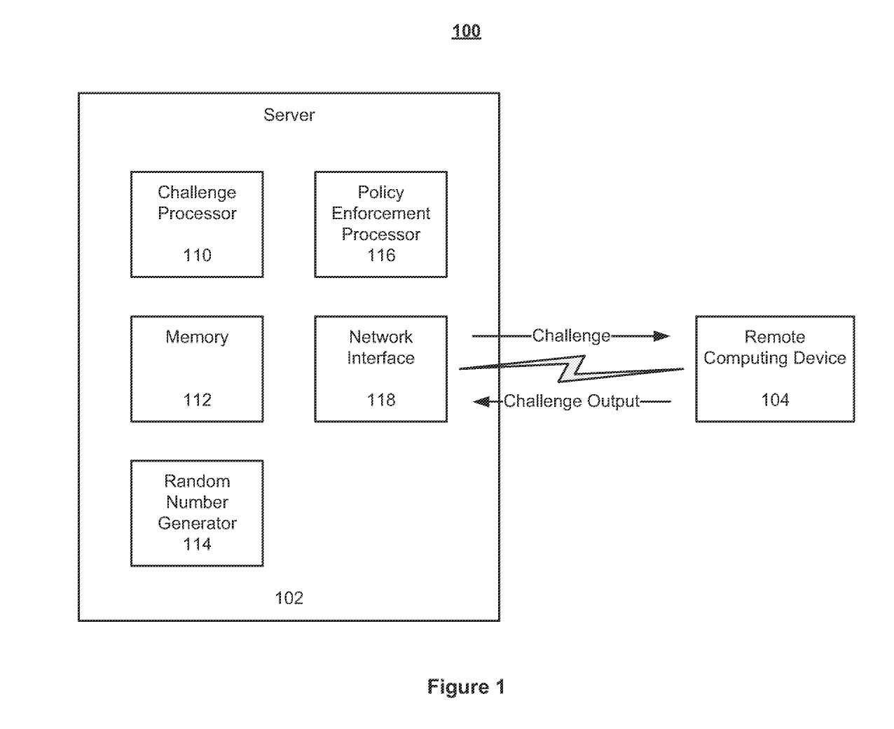

FIG. 1 is an architectural model of a system 100 for verifying, using a server 102, the integrity of software running on a remote computing device 104. An integrity monitor, who is in some cases associated with a software producer and/or distributor, controls the server 102, which is used for verifying the integrity of software running on remote computing devices. The software company that produces and/or distributes the software may own the server 102 and employ the integrity monitor directly, or the integrity monitor and/or the server may be contracted. A user, who may have entered into a license agreement with the software producer or distributor, controls the remote computing device 104. In some situations, for example in voting software, the integrity monitor, such as a government employee, may not be associated with the software producer, and the user will not explicitly enter into a license agreement with the integrity monitor. In such situations, there may still be implicit codes of conduct for users of the computing device. In yet other situations, both the server 102 and the remote computing device 104 are owned and/or controlled by the same entity. The entity relies on the integrity monitor to ensure that the computing device 104 has not been attacked or undesirably modified. In such a situation, the computing device 104 may not be remotely located from the server 102. In this written description, any user of the software will be considered to have entered into an explicit or implicit agreement with the integrity monitor.

A network interface 118 of the server 102 is able to communicate with the remote computing device 104 over a communication channel in a network, such as the Internet, a cellular data network, or a local area network. In order to determine the integrity of a program running on the remote computing device 104, the server 102 selects and sends a challenge to the remote computing device 104 over the connection as shown. The challenge causes the remote computing device 104 to generate a challenge output, which is received at the network interface 118 of the server 102. Additional server modules, including a challenge processor 110, a memory 112, a random number generator 114, and a policy enforcement processor 116, are used for selecting the challenge, interpreting the challenge output, and as necessary, responding to the integrity decision.

The program running on the remote computing device 104 and, in some cases, even the remote computing device 104, are specially designed to be able to accept challenges. The code for the program running on the remote computing device 104 may include hooks, explicit sections or execution areas designed to accept injected code, and/or other features that allow the computer program to accept and perform challenges. The challenges are designed in view of the features of the computer program and the remote computing device 104 for accepting code injections or other types of challenges.

As shown in FIG. 1, the server 102 can directly observe or receive the challenge output from the remote computing device. Challenges that the server 102 may send to the remote computing device 104 to verify the integrity of a program include hash functions applied to an executable file for running software on the remote computing device 104, data generated or used by the software, or code of a particular software process running on the remote computing device 104. The server 102 causes code to be injected into a process, causing the remote computing device 104 to generate and return the challenge response. Many suitable hash algorithms, e.g. SHA-1, SHA-2, and MD5, exist, and any other suitable hash algorithm may be used. In some embodiments, the challenge includes requiring the computing device to establish a network connection with the server 102 to send the challenge response, or simply to establish a network connection with the server. Other challenges involve requesting information about processes running on the remote computing device, such as data indicating whether a debugger is running, whether an emulator or virtual machine is running, or whether additional software is running. If a debugger is running, the challenge or a subsequent challenge may seek out which software is being debugged. Additional challenges include examining if hooks have been inserted into dynamic libraries, OS services, or kernel drivers on the remote computing device. The challenge may examine information related to an OS activity report. Another challenge may request a sample of numbers generated by a pseudorandom number generating module on the remote computing device 104 to test if malware is skewing the pseudorandom number generator. A single challenge may include multiple sub-challenges.

Challenges may be designed to test device software, firmware, or hardware and can measure behaviors indicative of performance, control flows, input/output or any other typical computer behavior. Challenges can be false challenges which, if the remote computing device 104 has been modified, may elicit a response where one is not expected. Challenges may be designed to return incorrect responses to discover malware that has learned correct responses.

In some cases, the types of permissible challenges are terms of the license agreement or follow other privacy guidelines. For example, challenges may only be directed to the software, or only to processes that could be directly related to the software, such as a debugger. In other cases, the software producer or licensor may require the user grant wider access to investigating processes and configurations on the remote computing device 104. The user may be required to provide the capability for challenges as part of the license agreement. The agreement may specify that the scope of the challenges may increase if the user appears to be in violation of the agreement.

The remote computing device 104 may be any computing device known in the art including a personal computer, a laptop computer, a notebook, a netbook, a tablet computer, a personal digital assistant, a mobile device, or other computing devices capable of running a computer program. The remote computing device 104 may be a mobile device, such as a cell phone, smart phone, or similar handheld device. The remote computing device 104 may be running one or more computer programs, but in general, the server 102 will be interested in a single computer program or software package running on the remote computing device 104. In some implementations, the server 102 is instead interested in firmware on embedded systems or other electronic devices; the methods disclosed herein may be used to verify firmware operating on such systems.

The remote computing device 104 may have a wired connection to a network, such as dial-up or broadband Internet connection (e.g. DSL, cable, DS1, etc.), or a wireless connection to a network (e.g. Wi-Fi, satellite, 3G/4G). The computing device may alternatively be connected to the server 102 through a local area network, implemented using, for example, Ethernet, Wi-Fi, or a wired connection. For many applications where the remote computing device 104 is a personal computer or a mobile device, the server 102 will connect to the remote computing device though the Internet or a cellular network. A local area network may be used in a casino offering computerized games or at a polling location. The network interface 118 of the server 102 is configured to connect to a network the remote computing device 104 is connected to so that the network interface 118 can send data to the remote computing device 104 and receive data from or observe a behavior of the remote computing device 104. The server 102 and the remote computing device 104 may be in non-networked communication; in this case, the server 102 may not include a network interface 118 but rather some other kind of communication device.

In addition to the network interface 118, the server 102 includes a challenge processor 110, a memory 112, a random number generator 114, and a policy enforcement processor 116. The challenge processor 110 is configured to select a challenge to send to the remote computing device 104. Challenges or information related to a plurality of types or classes of challenges are stored on the memory 112, which is accessed by the challenge processor 110. Each challenge is designed to determine whether a program or an aspect of a program running on the remote computing device 104 has been modified. A process running on the remote computing device 104 should not be able to predict the challenge or be able to spoof the expected output. In order to significantly decrease the ability of the remote computing device 104 to generate the expected challenge output even when the program running on the remote computing device 104 has been modified, the challenge processor 110 selects each challenge in an unpredictable manner. Unpredictable challenge selection can be accomplished by randomly or pseudo-randomly selecting, from the types or classes of challenges stored in memory, a type or class of challenge. Additionally or alternatively, the challenge processor 110 can randomly or pseudo-randomly select particular challenge parameters. A random process is not required for unpredictable challenge selection; the remote computing device 104 cannot predict challenges that it does not know of or has not received before, even if the challenge was not randomly selected.

The random or pseudo-random challenge or parameter selection is performed by a random number generator 114. For example, each type of challenge in memory may be assigned an index; the random number generator 114 would be used to randomly select an index of a challenge. A particular challenge may be adjusted using parameters. For example, for a cryptographic hash function, the block size for hashing may be randomized. Additionally or alternatively, the software element to analyze using the challenge may be selected randomly. For example, a block of code or a particular data file and/or location within a data file to hash, analyze, or return may be selected at random. Non-uniform random distributions may be used; for example, the likelihood of selecting for hashing a data file that a user is likely to modify may be higher than the likelihood of selecting a data file that a user would have little incentive to modify.

In some implementations, the challenge processor 110 uses the random number generator 114 to determine a delay after which the remote computing device 104 should execute the challenge. This is useful in detecting modified software if the software running on the remote computing device 104 is configured to, upon receipt of an apparent challenge, revert to an unmodified version or execute an unmodified emulation for a period of time before returning to its modified state or closing the emulation. By introducing the delay, there is an increased likelihood that such software will be returned to its modified state or such emulation will be closed before the challenge is executed, thereby increasing the odds of detecting a modification.

The random number generator 114 may use any random or pseudo-random number generation technique known in the art. The random number generator 114 may be a software pseudo-random number generator or, for true randomization, a hardware random number generator may be employed. If the random number generator 114 is software-based, it may be incorporated into the challenge processor 110.

In addition to selecting the challenge and any additional challenge parameters, the challenge processor 110 is also configured to examine the challenge output to assess whether the integrity of the software has been compromised. If the integrity monitor is associated with the software producer or distributor, they may have access to the binary code and data files. This would allow the challenge processor 110 to determine the expected output of a certain challenge, such as a hash function, and compare the expected output to the output received from the remote computing device 104. The server 102 is also configured for interpreting the output of other kinds of challenges, for example information returned related to processes running on the remote computing device 104. The identification of certain processes running on the remote computing device 104, such as debugging software or an emulation, may indicate an increased likelihood that the remote computing device 104 is breaking or may attempt to break the license agreement.

In some embodiments, the server 102 is also configured to run the software or an emulation that runs the software. Challenges sent to the remote computing device 104 are also sent to the software running at the server, and the challenge output from the remote computing device 104 is compared to the challenge output from the software or emulation on the server 102. Depending on the type of connection between the server 102 and remote computing device 104, the server 102 may be able to fingerprint the remote computing device 104 using known device fingerprinting techniques and emulate its configurations on an emulation or virtual machine. In some implementations, the software or emulation runs on a second server or another computing device in communication with the server 102.

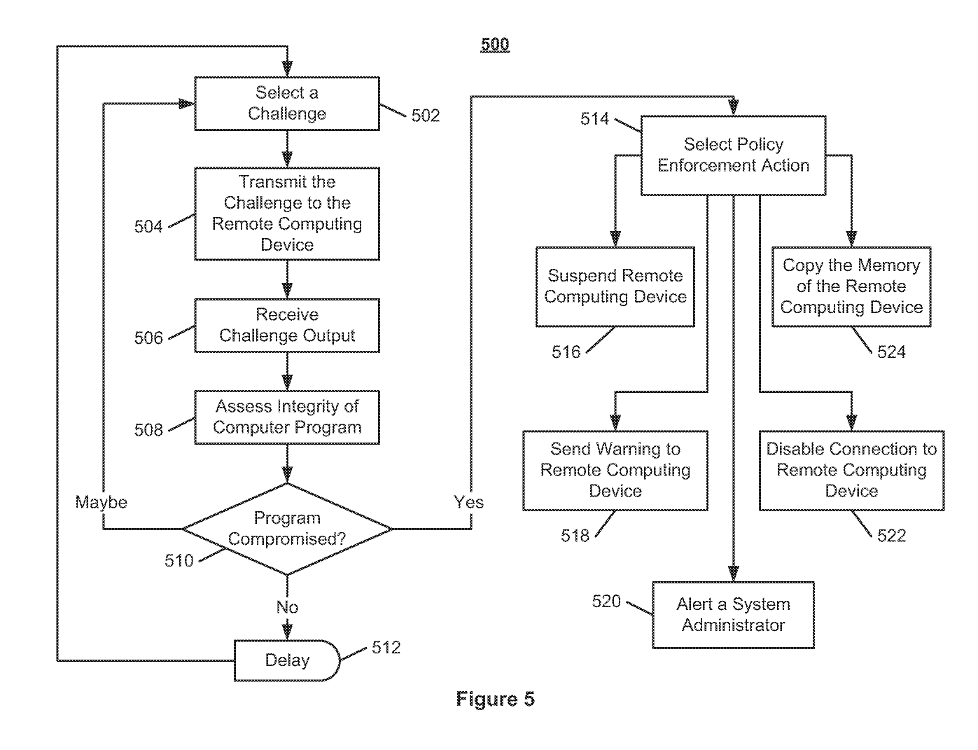

The server 102 also includes a policy enforcement processor 116. The policy enforcement processor 116 determines, from the assessment of whether the integrity of the software on the remote computing device 104 has been compromised by the challenge processor 110, what if any action should be taken to enforce the license agreement. The actions taken are based on the type and output of the challenge and the agreement in place. Possible actions include instituting a temporary suspension of capabilities in the software on the remote computing device, generating a warning for delivery to the remote computing device, executing a command to disable the connection between the remote computing device and the system thereby preventing usage of the software, executing a command to copy the memory of the remote computing device, and issuing an alert to a system administrator. These policy actions and their selection are discussed in further detail in relation to FIG. 5. In some implementations, the policy enforcement processor 116 is incorporated into the challenge processor 110.

Although FIG. 1 shows only a single remote computing device 104, in many embodiments, the server 102 is connected to a plurality of remote computing devices. The server 102 may send the same challenge to each remote computing device, or may select independent challenges for individual remote computing devices or for groups of remote computing devices.

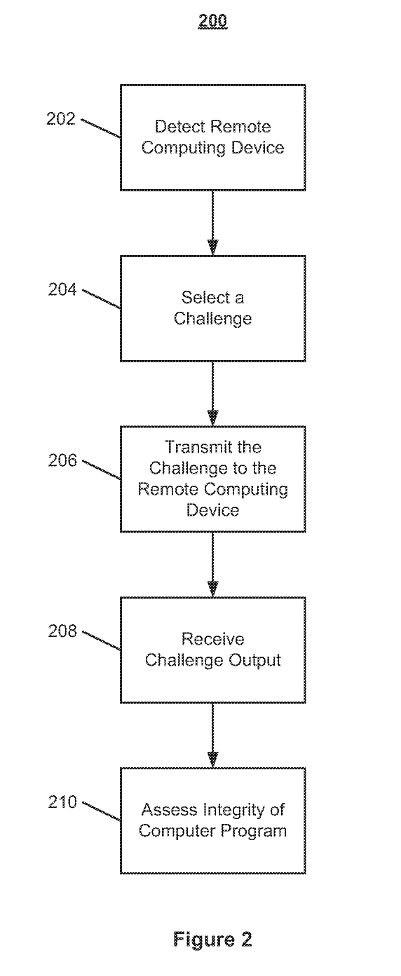

FIG. 2 is flowchart of a method 200 for verifying the integrity of a remote computing device using a server such as the server 102 described in relation to FIG. 1. The method begins with the server detecting a remote computing device running software (step 202), selecting a challenge for the remote computing device (step 204), and transmitting the challenge to the remote computing device (step 206). The server then receives the challenge output (step 208) and assesses the integrity of the computer program (step 210).

First, the server 102 determines that a remote computing device, such as remote computing device 104, is connected to a network and running a particular computer program or software package (step 202). The server 102 may be configured to monitor a network for the presence of a remote computing device 104. In other implementations, the software upon being started automatically sends a message to the server indicating that it is running. In some embodiments, the user of the software must input user information, such as a user name, and verification information, such as a password or pin code, that are sent to the server for verification. The remote computing device 104 may be a client requesting services from the server 102 in a client-server model. Once the server establishes that the remote computing device is running the software (e.g. after launch or after password verification), the challenge processor 110 on the server 102 selects a challenge (step 204). The challenge may be selected in an unpredictable manner, for example using the random number generator 114 which can assist in selecting a type of challenge, a challenge target, and/or any other challenge parameters, as described in relation to FIG. 1. In some cases, a challenge is not predictable simply because the remote computing device 104 has not previously been sent the challenge. This can include challenges that were not generated or chosen using a random number generator. In certain cases, the challenge may be predictable, but if the environment or software of the remote computing device has been modified, it still may not be able to produce the correct challenge output. Additionally, the server 102 may set an allotted time that the remote computing device 104 has to generate the challenge output, which may depend on the delay for executing the challenge. If the remote computing device takes too long to produce even the correct challenge output, it indicates that something is amiss on the remote computing device 104, such as the user or a program trying to reverse engineer the software to properly respond to the challenge.

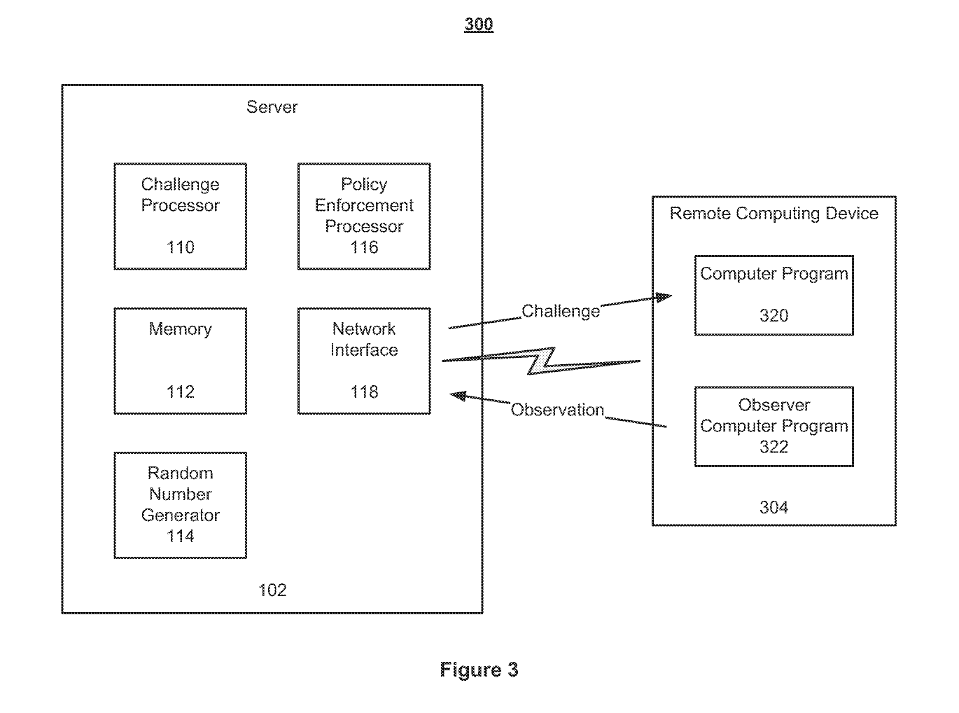

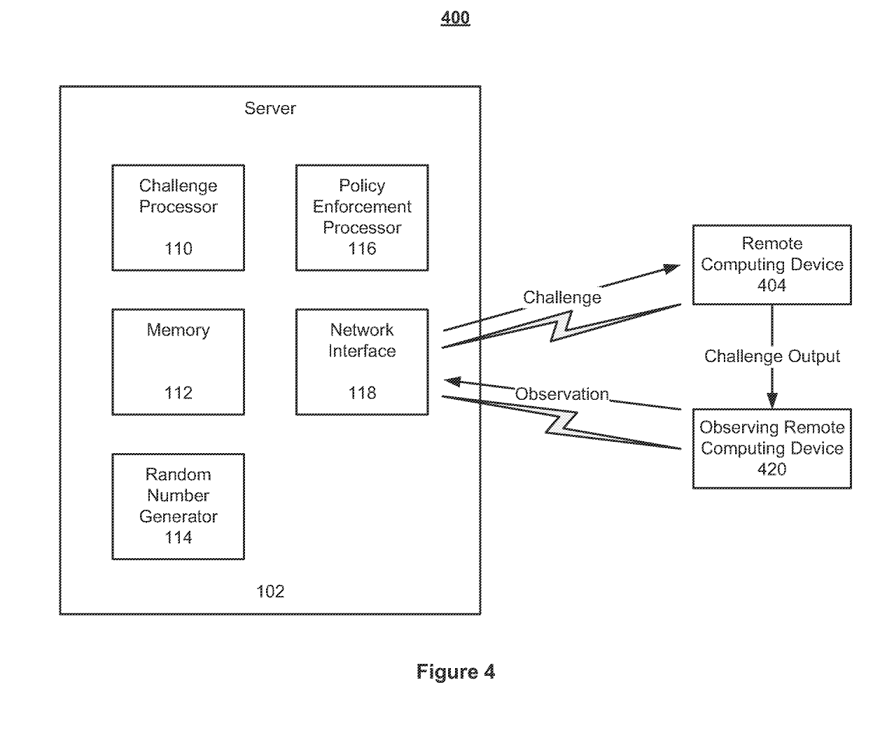

The server 102 then transmits the challenge to the remote computing device 104 over the network link (step 206). As discussed previously in relation to FIG. 1, the server 102 may specify a delay after which the remote computing device 104 should execute the challenge. The software running on remote computing device 104 is configured to accept the challenge as a code injection, and if unmodified, it executes the challenge as requested. A user's modifications to the software or the computing environment may affect the execution of the challenge. In one example, if the user of the remote computer 104 is attempting to run a modified version of the software, the user may run a second instance of the software, which may run on a virtual machine on the remote computer 104. While the user is using the modified instance of the software, he runs the other, non-modified version to respond to challenges. While in certain cases this second instance may generate the expected challenge output, as discussed in FIGS. 3 and 4, modifications such as this can cause observable side effects.

After the challenge has executed, the server 102 receives the challenge output (step 208). The challenge output may include hash values, data related to processes running on the remote computing device, and device fingerprint information. In some implementations, the challenge output includes the local time from the remote computing device or a time interval spanning, for example, the receipt of the challenge to the execution of the challenge. This timing information can indicate whether or not the software that responded to the challenge is running on a virtual machine, as common emulation processes are configured to start upon receiving a challenge and pause when it is not needed for spoofing. Thus, the emulation may not exhibit the passage of time as though it were constantly running.

The server 102 then assesses from the challenge output the integrity of the computer program on the remote computing device (step 210). The challenge processor 102 compares the challenge output to the expected challenge output, and if the challenge output is not an expected output or, in some cases, not in an acceptable range, the challenge processor 110 determines that the program may have been modified or that the user's behavior may otherwise not be in accordance with the agreement between the user and the integrity monitor. As will be discussed further in relation to FIG. 5, the policy enforcement processor 116 may take action when the challenge processor 110 determines that the agreement may have been violated.

FIG. 3 is an architectural model of a system 300 for verifying the integrity of a remote computing device running a plurality of computer programs, according to an illustrative embodiment. In this system, the server 102 is similar to the server 102 described in relation to FIG. 1. The server 102 is again in communication with a remote computing device 304, which is similar to remote computing device 104. In this embodiment, the remote computing device 304 is running at least two computer programs (320 and 322). The computer programs may be part of the same software package; for example, when the user installs the software, the user installs both the computer program 320 which he is using, and an observer computer program 322 that runs in the background. The user may not be aware of the observer computer program 322.

When the remote computing device 304 receives a challenge, the observer computer program 322 may observe a side effect of the computer program 320 executing the challenge. For example, the challenge may cause the computer program 320 to create or modify a file, which is observed, read, or hashed by the observer computer program 322. The challenge may alternatively cause the computer program 320 to launch an additional process on the remote device, and the observer computer program 322 can observe which processes are running. In some implementations, the observer computer program 322 only runs by a command from the server 102 or when the computer program 320 launches it when prompted by the challenge. The observer computer program 322 may be configured to return information related to the environment and behavior of the remote computing device when prompted by the server, such as when a challenge is received; when the observer computer program 322 detects unusual circumstances, such as irregular user behavior or achievements; or in regular intervals.

FIG. 4 is an architectural model of a system 400 for verifying, using a second computing device, the integrity of a remote computing device, according to an illustrative embodiment. As described in relation to FIG. 1, the server 102 sends a challenge to a remote computing device 404, which is similar to remote computing device 104. In this embodiment, the challenge causes the remote computing device 404 to produce a side effect that another computing device can observe. Side effects include initiating network connections to another computing device or to the server 102 and generating network packets that could be observed by an observing remote computing device 420. The observing remote computing device 420 may be configured to automatically send information related to new network connections, network packets, or other side effects to the server 102. In some embodiments, the observing remote computing device 420 may receive a command from the server 102 to send information to the server related to any observed side effects in a given time period. In yet other embodiments, the server 102 sends a command to the observing remote computing device 420 to actively seek such side effects.

This architecture is particularly valuable for detecting whether the user is using an emulation to spoof the server 102. The challenge may request that the computer program produce a network packet or another side effect visible to another computing device on the same network as the remote computing device 404. If the remote computing device 404 is configured to send challenges to an unmodified program running on an emulation that is not otherwise connected to a network, the emulation will not transmit the network packet to the network. The observation that no network packet was received indicates that the user may be trying to spoof the server through an emulation.

Although not shown, additional observing remote computing devices may receive the challenge output. The challenge processor 104 can compare observations of several remote computing devices to each other and, in some cases, to an additional observation at the server 102. In some embodiments, observing remote computing devices are connected to the remote computing device 404 through different networks. For example, one observing device may be connected to the remote computing device 404 through a local are network (LAN), while a different observing device is connected to the remote computing device 404 through the Internet.

FIG. 5 is flowchart of a method 500 for ensuring the integrity of a remote computing device, according to an illustrative embodiment. The method includes many of the same steps (steps 502-508) as the method described in relation to FIG. 2, which can be performed in one of two loops, based on whether the device may be compromised or is not compromised. The method also includes taking policy enforcement actions (steps 514-524) if the integrity has been compromised.

The method 500 begins with the steps of selecting a challenge for determining the integrity of a computer program on a remote computing device (step 502), transmitting the challenge to the remote computing device (step 504), receiving the challenge output (step 506), and determining the integrity of the computer program (step 508), all of which are performed in a similar manner as steps 204-210, respectively, discussed above in relation to FIG. 2. From this integrity assessment, the challenge processor 110 determines if the integrity of the program running on the remote computing device has been compromised. Although the method 500 shows only one challenge being selected and executed at a time, multiple challenges could be operating simultaneously. For example, a first challenge may generate a response only after a delay to spoof a false responder to respond early. While this challenge is being selected and transmitted or after it has been transmitted, but before the challenge output has been received, one or more additional challenges could be transmitted to the same remote computing device. The additional challenge or challenges may be faster to execute and require a shorter delay or no delay. Furthermore, a transmitted challenge may include multiple sub-challenges, e.g., a first sub-challenge that requests an immediate response and a second sub-challenge that requests a delayed response. The sub-challenges may be the same type of challenge or different types of challenges.

If the challenge output clearly indicates that the program has not been compromised and that the agreement with the integrity monitor has not been violated, the method proceeds to delay step 512, after which the process loops back to step 502, selecting a challenge. The method loops back to step 502 because, even if the output indicates that at the present time the user and the program are in accordance with the agreement, the integrity of the program may be compromised at a later time. However, it would not be efficient to repeatedly challenge the remote computing device. Therefore, a delay 512 is in place for resource efficient but continued analysis of the remote computing device. The delay 512 may be a set time, a time based on the previous challenge selected, a randomly chosen time, or a time selected through other means.

In many cases, the challenge output will suggest that the agreement may be violated, but may not clearly indicate that the program has been compromised, in what way the agreement was violated, or what the user's intentions are. For example, if the challenge output indicates only that the remote computing device has an emulation running, this does not necessarily violate the agreement, but it suggests that the agreement may have been violated. This type of result requires further investigation into the integrity of the software, so immediately another challenge is selected (step 502). The challenge processor 110 may select the challenge based on the previous challenge and/or the previous challenge output. In some situations, the challenge processor 110 may choose a different type of challenge to learn new information; in other situations, the challenge processor 110 may choose a similar type of challenge for confirmation of the previous result. In some embodiments, the amount of outside involvement (e.g. use of additional processes on the remote computing device or use of additional remote computing devices) escalates as the server 102 becomes more suspicious that the agreement is being violated. The challenge processor may be able to determine based on previous challenge outputs what additional information is needed to definitively determine whether the program is compromised, and which challenge or challenges would return the necessary output.

If the challenge processor determines that the program has indeed been compromised, the policy enforcement processor 116 then selects a policy enforcement action (step 514). Exemplary policy actions are shown as steps 516-524. The action chosen depends on the type of software and/or the type of violation of the agreement. The severity of the actions varies. For example, in many situations, like an online game, a minor infraction or uncertain violation of the agreement may warrant an action that does not affect the user's use of the software, such as an alert created and sent to a system administrator (step 520) or a warning sent to the remote computing device (step 518). A more egregious violation of the agreement would cause the policy enforcement processor to take a more invasive action, such as copying the memory of the remote computing device (step 524), and/or an action that impacts the user's ability to continue using the software, such as suspending the remote computing device from certain capabilities or from using the software (step 516) or disabling the connection to the remote computing device (step 522). If misuse of software or violation of a license agreement may have greater significance, such as with high-stakes gambling software or software on a voting machine, the policy enforcement processor 116 may suspend the device or disable the connection at more minor violations. Some policy enforcement actions, such as copying the memory of the remote computing device (step 524), may only be permitted under certain situations in accordance with privacy guidelines and license agreements in place. While some of the aforementioned actions prevent continued use of the software, in others, the user may continue to use the software. If the user is permitted to continue using the software, the method returns to step 502, possibly after a delay (not shown).

In some embodiments, the policy enforcement processor 104 is configured to create an alert or message for a system administrator if there is any indication that the integrity of software running on a particular remote computing device may have been compromised, potentially in violation of a license agreement. Such a message could be created either after a “Yes” result or a “Maybe” result after decision 510. The message contains an identifier (e.g. IP address, MAC address, user data, and software serial number) of the remote computing device, the output of one or more challenges, the time each challenge was selected, and the time each challenge output was observed. In addition to being sent to the system administrator, the message can be delivered to the user of the computing device 104, a security expert, the producer or distributor of the software, or any other interested party. The message may additionally or alternatively be stored on a database or data store on the server 102.

While method 500 includes a delayed loop after a “No” result after decision 510, in certain embodiments, the verification process may simply stop if the software has not been modified. In some embodiments, a challenge or sequence of challenges is only sent to the remote computing device soon after the remote computing device has started running the software. This may be part of a user verification process. For example, the integrity monitor may want to confirm that a security patch has been applied. The server 102 could send a challenge for verifying that the security patch has been applied, and after receiving verification, never make the query again since security patches rarely are removed.

In some implementations, the server 102 may be replaced by a bank of servers, and functionality may distributed across several servers. For example, one or more servers may be configured for the challenge processing, while one or more separate servers are configured for policy enforcement. The memory 112 and/or random number generator 114 may be on the server 102 or separate from the server 102. Servers may be housed in a single location or distributed. Servers may be identical and used to send challenges to different remote computing devices. The architectures described in relation to FIGS. 1, 3, and 4 are not limiting, and alternative server architectures may be used for carrying out the methods such as method 200 and method 500.

While preferable embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for remote integrity verification comprising:
a challenge processor configured to select a challenge from a plurality of challenges for determining the integrity of a computer program on a remote computing device, wherein the challenge is selected in a manner which is substantially unpredictable by the remote computing device; and
a communication device in communication with the challenge processor to:
transmit the challenge to the remote computing device; and
receive an output of the challenge;
wherein the challenge processor is also configured to determine from the output of the challenge whether the integrity of the computer program on the remote computing device has been compromised.

2. The system of claim 1, wherein the challenge processor is configured to select the challenge from the plurality of challenges using one of a random number generator in communication with the challenge processor and a pseudorandom number generator.

3. The system of claim 1, wherein the challenge comprises executable code, and the executable code is injected into and executed by the computer program on the remote computing device.

4. The system of claim 1, wherein selecting the challenge comprises generating a hash function.

5. The system of claim 4, wherein one or more parameters of the hash function are selected in a substantially unpredictable manner.

6. The system of claim 1, wherein the challenge processor is configured to select a challenge requiring the computer program on the remote computing device to exhibit a behavior that can be observed by a second computer program on the remote computing device.

7. The system of claim 6, wherein the second computer program on the remote computing device is configured to report an observation of the behavior to the challenge processor.

8. The system of claim 1, wherein the challenge processor is further configured to:
select a challenge that causes the remote computing device to exhibit a behavior that is detectable by a second computing device; and
determine, from data from the second computing device related to evidence of the behavior of the remote computing device, whether the integrity of the computer program on the remote computing device has been compromised.

9. The system of claim 8, wherein the challenge processor is further configured to cause the communication device to transmit to the second computing device a command to detect the behavior of the remote computing device.

10. The system of claim 8, wherein the second computing device is in communication with the remote computing device through a network.

11. The system of claim 1, wherein the challenge processor is configured to select a delay after which the challenge is to be executed by the remote computing device.

12. The system of claim 11, wherein the delay is selected in a substantially unpredictable manner.

13. The system of claim 1, wherein the challenge processor is configured to select a deadline by which the output of the challenge must be received.

14. The system of claim 1, wherein the expected output of the challenge relates to aspects of the remote computing device other than the computer program.

15. The system of claim 1, wherein the challenge processor is configured to select a challenge whose output indicates whether actions of a user of the remote computing device are permissible according to a license agreement.

16. The system of claim 15, further comprising a policy enforcement processor configured to select for execution an action articulated by the license agreement if the actions of a user of the remote computing device are not permissible according to the license agreement.

17. The system of claim 16, further comprising a policy enforcement processor configured to select for execution, if the actions of a user of the remote computing device are not permissible according to the license agreement, at least one of a temporary suspension on the remote computing device, a warning for delivery to the remote computing device, a command to disable the connection between the remote computing device and the system, a command to terminate a user account, a command to copy the memory of the remote computing device, and an alert to a system administrator.

18. The system of claim 1, wherein, if the challenge processor determines from an output of a first challenge that the integrity of the computer program on the remote computing device may be compromised, the challenge processor is configured to:
select an additional challenge that is different from the first challenge;
cause the communication device to transmit the additional challenge to the remote computing device; and
evaluate the output of the additional challenge.

19. A method for remote integrity verification comprising:
selecting, by a challenge processor, a challenge from a plurality of challenges for determining the integrity of a computer program on a remote computing device, wherein the challenge is selected in a manner which is substantially unpredictable by the remote computing device;
transmitting the challenge to the remote computing device; and
receiving, from the remote computing device, an output of the challenge; and
determining, by the challenge processor, whether the integrity of the computer program on the remote computing device has been compromised based on the output of the challenge.

20. The method of claim 19, further comprising selecting, by the challenge processor, the challenge from the plurality of challenges using one of a random number generator in communication with the challenge processor and a pseudorandom number generator.

21. The method of claim 19, wherein the challenge comprises executable code, the method further comprising:
injecting the executable code into the computer program on the remote computing device; and
executing the executable code by the computer program on the remote computing device.

22. The method of claim 19, wherein selecting the challenge comprises generating, by the challenge processor, a hash function.

23. The method of claim 22, further comprising selecting, by the challenge processor, one or more parameters of the hash function in a substantially unpredictable manner.

24. The method of claim 19, further comprising:
selecting, by the challenge processor, a challenge requiring the computer program on the remote computing device to exhibit a behavior; and
observing, by a second computer program on the remote computing device, the behavior.

25. The method of claim 24, further comprising reporting, by the second computer program on the remote computing device, an observation of the behavior to the challenge processor.

26. The method of claim 19, further comprising:
selecting, by the challenge processor, a challenge that causes the remote computing device to exhibit a behavior that is detectable by a second computing device; and
determining, from data from the second computing device related to evidence of the behavior of the remote computing device, whether the integrity of the computer program on the remote computing device has been compromised.

27. The method of claim 26, further comprising generating, by the challenge processor, a command to be transmitted by a communication device to the second computing device to detect the behavior of the remote computing device.

28. The method of claim 26, wherein the second computing device is in communication with the remote computing device through a network.

29. The method of claim 19, further comprising selecting, by the challenge processor, a delay after which the challenge is to be executed by the remote computing device.

30. The method of claim 29, further comprising selecting, by the challenge processor, the delay in a substantially unpredictable manner.

31. The method of claim 19, further comprising selecting, by the challenge processor, a deadline by which the output of the challenge must be received.

32. The method of claim 19, further comprising selecting, by the challenge processor, a challenge whose expected output relates to aspects of the remote computing device other than the computer program.

33. The method of claim 19, further comprising selecting, by the challenge processor, a challenge whose output indicates whether actions of a user of the remote computing device are permissible according to a license agreement.

34. The method of claim 33, further comprising selecting for execution, by a policy enforcement processor, an action articulated by the license agreement if the actions of a user of the remote computing device are not permissible according to the license agreement.

35. The method of claim 34, further comprising selecting for execution, by a policy enforcement processor, if the actions of a user of the remote computing device are not permissible according to the license agreement, at least one of a temporary suspension on the remote computing device, a warning for delivery to the remote computing device, a command to disable the connection between the remote computing device and the system, a command to terminate a user account, a command to copy the memory of the remote computing device, and an alert to a system administrator.

36. The method of claim 19, further comprising:
determining, by the challenge processor, that the integrity of the computer program on the remote computing device may be compromised from an output of a first challenge;
selecting, by the challenge processor, an additional challenge that is different from the first challenge;
transmitting the additional challenge to the remote computing device; and
evaluating the output of the additional challenge.

37. A non-transitory computer readable medium having stored therein instructions for directing a processor to implement a method for remote integrity verification comprising:
selecting a challenge from a plurality of challenges for determining the integrity of a computer program on a remote computing device, wherein the challenge is selected in a manner which is substantially unpredictable by the remote computing device;
transmitting the challenge to the remote computing device; and
receiving, from the remote computing device, an output of the challenge; and
determining whether the integrity of the computer program on the remote computing device has been compromised based on the output of the challenge.
